(19) United States
(12) Patent Application Publication
(10) Pub. No.: US 2016/0210877 A1
(43) Pub. Date: Jul. 21, 2016

(54) SYSTEMS AND DEVICES FOR TRAINING AND ASSESSMENT OF FOOTBALL PLAYERS

(71) Applicants: Dalton Young, McKinney, TX (US); Jeff Nelson, Maple Valley, TX (US)

(72) Inventors: Dalton Young, McKinney, TX (US); Jeff Nelson, Maple Valley, TX (US)

(21) Appl. No.: 15/002,797

(22) Filed: Jan. 21, 2016

Related U.S. Application Data
(60) Provisional application No. 62/106,105, filed on Jan. 21, 2015.

(51) Int. Cl. G09B 19/00; G09B 5/02

(52) U.S. Cl. CPC G09B 19/0038; G09B 5/02

(57) ABSTRACT

Systems and devices for training and assessment of football players are described herein. In particular, systems and devices for measuring the speed of a football player and/or impact force after a simulated snap are described. In some examples, a computing device with an internal accelerometer is used. In some further examples, the assessment system includes a personal computer.

### CROSS REFERENCE TO RELATED APPLICATIONS

This application claims priority to copending U.S. Provisional Application, Ser. No. 62/106,105, filed on Jan. 21, 2015, which is hereby incorporated by reference for all purposes.

### BACKGROUND

The present disclosure relates generally to systems and devices for training and assessment of football players. In particular, systems and devices for measuring the speed of a football player and/or impact force after a simulated snap are described.

Football player statistics are often used for assessment of teams and individual players. Further, player statistics can be used to develop training goals and targets for player and team improvement. Finally, individual football player statistics can be reported to universities and professional teams during player recruitment.

Known football player training and assessment systems are not entirely satisfactory for the range of applications in which they are employed. For example, existing football player training and assessment systems can provide statistical data for certain positions (e.g., number of completed passes for a quarterback, average speed of a 40 yard dash for a running back, etc.); however, other position statistics are not readily recorded and/or reportable. In addition, conventional football player training and assessment systems record statistical data for only a single player.

Thus, there exists a need for football player training and assessment systems that improve upon and advance the design of known training and assessment systems. Examples of new and useful football player training and assessment systems and devices relevant to the needs existing in the field are discussed below.

### BRIEF DESCRIPTION OF THE DRAWINGS

FIG. 1 shows a schematic view of an example of a programmable computing device.

FIG. 2 shows a schematic view of an example of a mobile electronic device.

FIG. 3 shows a schematic view of a first example of a football player training and assessment system.

FIG. 4 shows a flowchart depicting the steps for football player training and assessment according to an embodiment of the present invention.

### DETAILED DESCRIPTION

The disclosed football player training and assessment systems and devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of football player training and assessment systems and devices examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

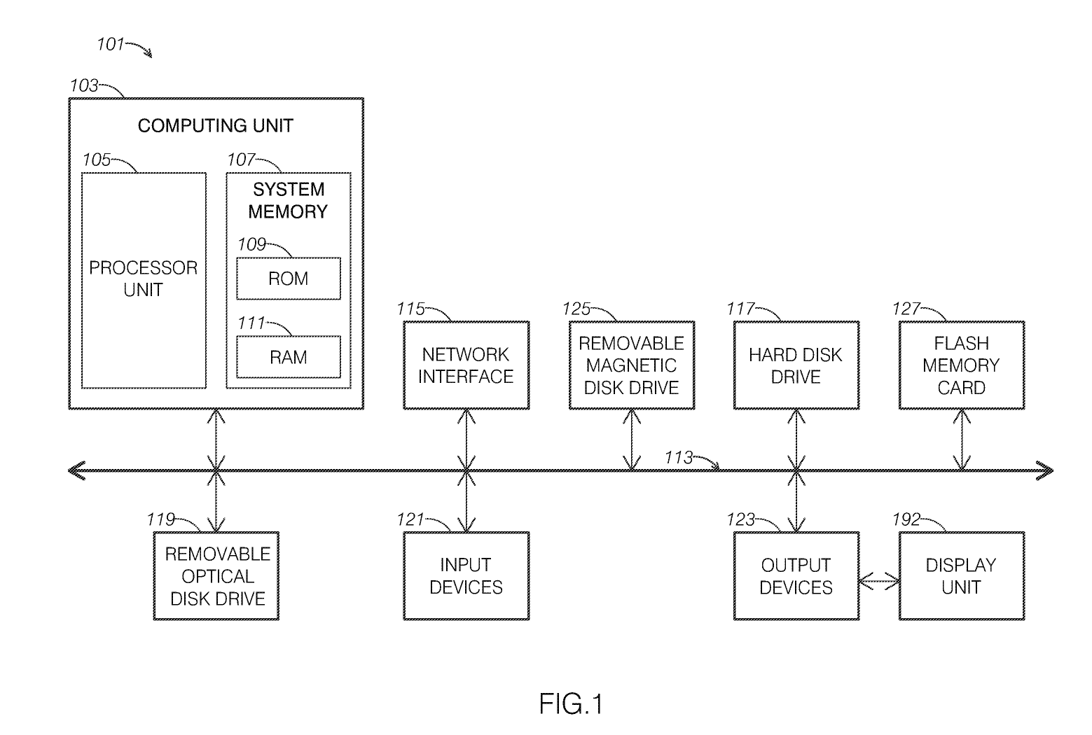

With reference to FIGS. 1-4, a first example of a football player training and assessment system, training and assessment system 300, will now be described. Training and assessment system 300 functions to provide a mechanism for collecting data for one or more football players that can be used during training to improve technique and play for individuals and/or for a team. Additionally or alternatively, training and assessment system 300 can be used to collect and report statistics for individual players.

Training and assessment system 300 addresses many of the shortcomings existing with conventional football player training and assessment systems and devices. For example, data for dash times and/or blocking (i.e., tackling) forces can be collected for linemen and other players that are in more difficult positions for which to collect data. In another example, data collection can be recorded for a single player, individual players in a team, and/or for the team as a whole.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

Accordingly, FIG. 1 shows one illustrative example of a computer, computer 101, which can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115 is also sometimes referred to as a network adapter or network interface card (NIC). Network interface 115 translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android or Windows or other OS based smartphone or wearable device. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS or Windows or other OS based smartphone or wearable device or operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according to the various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian, Windows-based (including Windows Mobile and Windows 8), or Android operating systems.

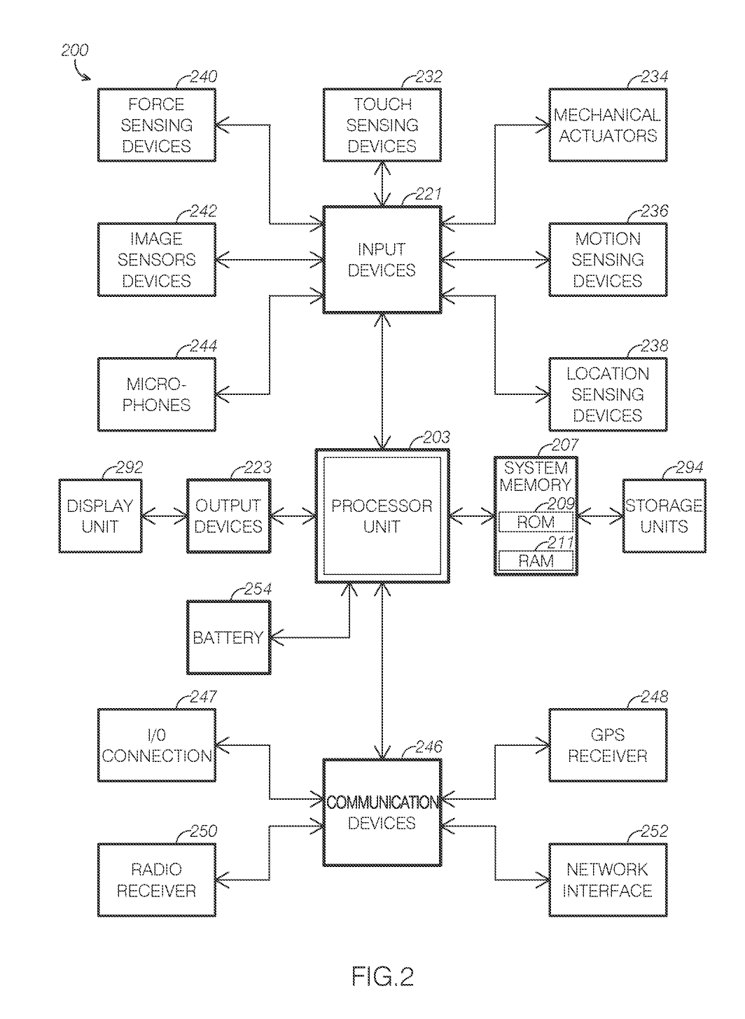

With reference to FIG. 2, an exemplary mobile device, mobile device 200, may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well-known operating systems such as iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211, etc. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include the following: touch sensing devices 232 such as touch screens, touch pads and touch sensing surfaces; mechanical actuators 234 such as button or wheels or hold switches; motion sensing devices 236 such as accelerometers; location detecting devices 238 such as global positioning satellite receivers, WiFi based location detection functionality, or cellular radio based location detection functionality; force sensing devices such as force sensitive displays and housings; image sensors; and microphones. Input devices 221 may also include a clickable display actuator.

Mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

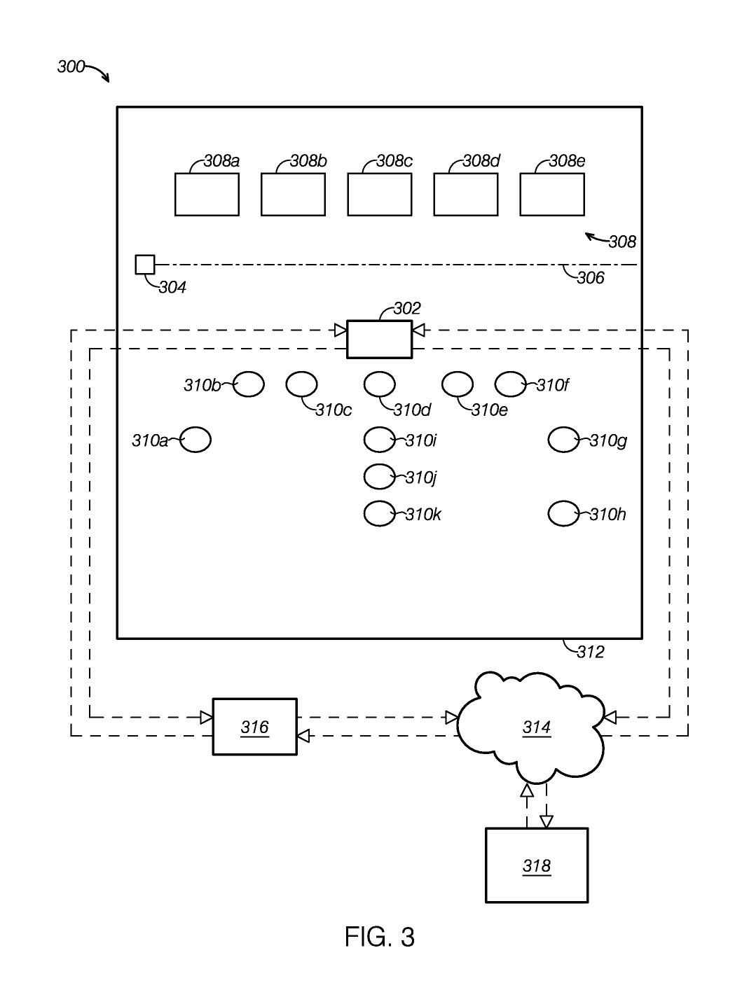

Turning now to FIG. 3, training and assessment system 300 includes a timing and data collection device 302, a position sensing device 304 that senses timing of a disruption of a virtual line 306, and impact pressure sensing devices 308 (308a-308e) for use with a plurality of football players 310 (310a-310k) involved in a training and/or assessment exercise. The various components of the training assessment system and the football players described above are located on a playing field 312.

In some examples, the training and assessment system can include more or fewer impact pressure sensing devices, or even exclude impact pressure sensing devices. Additionally or alternatively, each of the players can carry an electronically-readable unique tag that can be read by the position sensing device. In some other examples, the training and assessment system can exclude the position sensing device and instead use a timing of impact against the impact pressure sensing devices to collect timing data. It will be appreciated that the training and assessment system can be used to assess a single player or a group of players according to the user's needs. The training and assessment system can be used with as few as one football player, to an entire team or even groups of teams.

In still other examples, the training and assessment system can include a separate data collection device that is remote relative to the timing device and/or the playing field, such as a personal computer 316. It should be understood that it is an object of the present invention to not require an actual laser line (as created by, for example, a laser pointer); the preferred embodiment utilizes accelerometers that are built into a smart phone or wearable fitness device. As depicted in FIG. 3, timing and data collection device 302 can be in communication with a network location 314 and/or a personal computer 316. Further, personal computer 316 may be in communication with network location 314. Furthermore, network location 314 may be in communication with a database 318 for storage of collected data and/or various training and assessment programs that can be used with training and assessment system 300.

As can be seen in FIG. 3, timing and data collection device 302 is substantially located in front of football players 310. In the present example, the timing and data collection device is a computer, such as computer 101 or mobile device 200 described above. The timing and data collection device can wirelessly communicate (e.g., via Bluetooth, WiFi, etc.) with the position sensing device, the impact pressure sensing devices, the network location, and/or the personal computer. In other examples, the timing and data collection device can be in wired communication with the position sensing device, the impact pressure sensing devices, the network location, and/or the personal computer.

The timing and data collection device is configured to provide a signal that represents a simulated snap of a football (i.e., a beginning of a play). A timing of the signal to initiate play can be randomized so that the football players cannot anticipate when the signal will be emitted. In some examples, the signal is a visual signal (e.g., a blink of a light, a change of color of a light, etc.). Alternatively or additionally, the timing and data collection device can provide an auditory signal (e.g., a buzz, a beep, a simulated countdown, etc.). In some examples, the timing and data collection device is configured in the shape of football.

After receiving the signal from timing and data collection device 302, football players 310 can then initiate a training play. For example, football players 310 can run forward towards virtual line 306 and impact pressure sensing devices 308. Data can then be recorded for a timing of one or more the players to pass virtual line 306 and/or pressure of body impact for one or more of the players against impact pressure sensing devices 308.

In the example shown in FIG. 3, position sensing device 304 is configured to project virtual line 306 across the playing field 312. The position sensing device can be a laser and the virtual line can be a path of the laser beam. A disruption of the laser beam (e.g., a player running through the laser beam) can be used to record a timing of a play by one or more of the football players. In one example, timing is measured for each player individually by the laser reading an electronically-readable unique tag carried by each of the players. In another example, the laser can read and record a general start of play and/or a general end of play for all of the football players collectively. Alternatively, if the system is used with only a single football player, a single timing of disruption of the laser beam can be recorded.

After crossing virtual line 306, one or more of the players can simulate a tackle by running into impact pressure sensing devices 310. In one example, the impact pressure sensing devices are padded dummies that are generally the size and/or shape of a human. In another example, the impact pressure sensing devices are elongate vertically arranged pads configured to receive a shoulder of an oncoming football player during a training session. In both of these examples, the impact pressure sensing devices are configured to measure and record a pressure of the force of impact exerted by a football player onto the device (e.g., an impact force in pound-force per square inch [psi]). In some examples, the impact pressure sensing devices are configured to read the electronically-readable tag attached to each of the players and record the impact pressure specific to each player.

It will be appreciated that the timing and data collection device can be used to run subsequent training sessions. In some examples, the timing and data collection device is set to automatically run a new simulated snap at specific intervals (e.g., 2 mins, 3 mins, 5 mins, etc.). In other examples the timing and data collection device can be manually activated to begin a new simulated snap. Further, it will be appreciated the collected data (e.g., timing data and/or impact force data described above) can be stored in the timing and data collection device and/or sent to one or more of the network location, the database, and the personal computer. Furthermore, the data can be analyzed to determine statistical information for one or more of the football players individually and/or the football players collectively. Further still, statistical information can be used for performance evaluation.

In one specific example of use for training and assessment system 300, football players 310b and 310f are in “tackle” positions. Each of the players carries a unique electronically-readable tag that is attached to the wrist of a player via an elastic band. They players are aligned in a desired play pattern along a starting line. A coach or trainer initiates training and assessment system 300 via a command through personal computer 316 that is in wireless communication with timing and data collection device 302.

After a randomized delay period, a visual signal of a change in light coloration from red to green is emitted from timing and data collection device 102. Play is initiated and football players 310b and 310f run towards virtual line 306. A timing of the each players crossing virtual line 306 (i.e., timing data) is recorded by timing and data collection device 302 via reading of each of the unique electronically-readable tags by position sensing device 304.

Football player 310b then simulates a tackle into impact pressure sensing device 310a, while football player 310f simulates a tackle into impact pressure sensing device 310e. An impact pressure exerted by each of the players (i.e., impact pressure data) is recorded by timing and data collection device 302 via reading of each of the unique electronically-readable tags by impact pressure sensing devices 310 (i.e., impact pressure sensing devices 308a and 308e).

Timing data and impact pressure data for each of the football players are then sent to personal computer 316 and network location 314. Further, timing data and impact pressure data for each of the football players is sent to database 318. Within database 318 the data can be combined with data from additional team and/or football player data to calculate national and regional averages. Further, data for each of the players can be stored and later reported to recruiters.

It will be appreciated that the above described example is just one possible use for training and assessment system 300. It will be further appreciated that the system is dynamic and can be adapted for training or assessment of a single player and/or adapted for specific desired training conditions selected by a coach or trainer.

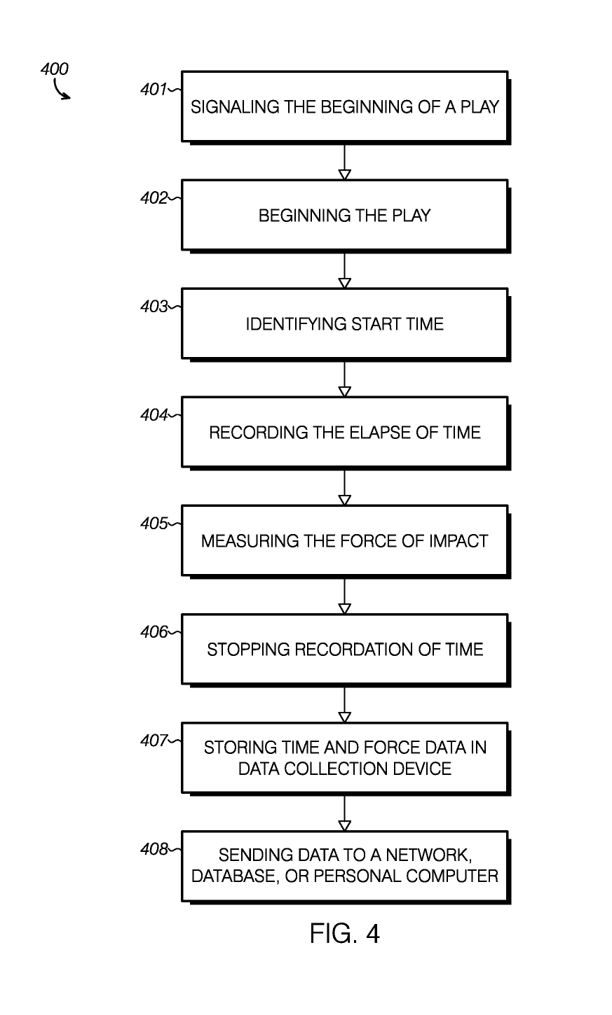

FIG. 4 shows a flowchart that represents a typical implementation of training and assessment system 300 according to an embodiment of the present invention. It should be understood that training and assessment system 300 may be operated by any person regardless of his or her connection with the team. In this manner, training and assessment system 300 may be operated by a player, a coach, or any other individual interested in benefiting from the object of the present invention.

In a preferred embodiment, training and assessment system 300 includes the steps of 401 signaling the beginning of a play; 402 beginning the play; 403 identifying start time at the beginning of the play and when each player passes virtual line 306; 404 recording the elapse of time; 405 measuring the force with which each player contacts pressure sensing device 308; 406 stopping the recordation of time and calculating total time, which is the total time from beginning to end of the play; sending the data for time and force to the network, the database, and/or the personal computer. In alternative embodiments, training and assessment system 300 may skip the step of measuring the force of impact and simply measure the amount of time it takes for the player or players to execute a play.

Step 401-signalling the beginning of the play-includes identifying the point at which the football players 310 begin execution of the play. As mentioned above, it can include a visual signal such as a blinking light or an auditory cue such as a whistle or beep. At this point, the players start (step 402) and move about behind the virtual line 306. When a player crosses virtual line 306 that is created by the position sensing device 304, the pressure sensing device 304 will interact with an electronically readable tag worn by the player and is recorded. In alternative embodiments, data collection device 302 and pressure sensing device may be manually activated to begin and end recording.

The play ends when the player interacts with pressure sensing device (step 405). The resultant data that is collected may be stored directly in data collection device and/or sent to a network location, a database, or a personal computer (steps 408). Thus, the user is free to analyze the collected data to evaluate a player, players, or team's overall performance. In alternative embodiments, a play can end manually (such as, for example, an auditory or visual cue like a whistle or a laser).

In alternative embodiments (not shown), a player may self-assess using a uniquely designed software application on his or her own smart device. In those embodiments, a player or players will attach the smart device and/or additional accelerometer device to a part of the body, such as a forearm or upper arm. The player will then ensure that the app and potential added accelerometer device are powered on and connecting. The athlete will start a software application using appropriate steps for the OS on the smart device. When the athlete is ready to begin a training event, s/he will select the drill, and tap a radio button marked “ready.” After a randomized period of time, the application will give a start signal. The athlete will then execute a play in the manner described above. Thus, the application will work with the smart device's accelerometers to measure, for example, reaction time between the time of the start signal and the start of motion, time between start of motion and impact on the target, and other desirable data.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A system for training and assessing football players' performance comprising:
a data collection device having a communication means, a timing means, and a recording means wherein the data collection device is capable of communicating with a network location and wherein the data collection device is capable of signaling at least one football player to begin execution of a play;
a position sensing device;
a plurality of pressure sensing devices;
a means for storing data and
at least one football player.

2. The system of claim 1, wherein the data collection device is a mobile device that is capable of wired or wireless communicating with the position sensing device.

3. The system of claim 1, wherein the data collection device is a computer with a central processing unit and a memory that is capable of wired or wireless communication with the position sensing device.

4. The system of claim 1, wherein the position sensing device further comprises a means for determining at least one football player's position.

5. The system of claim 4, wherein the position sensing device is configured to project a visible demarcation.

6. The system of claim 5, wherein the visible demarcation represents the point at which a data recordation begins and ends.

7. The system of claim 1, wherein the data collected is stored in a database.

8. The system of claim 1, wherein the data collection device may communicate via wired connection.

9. The system of claim 1, wherein the data collection device may communicate via wireless connection.

10. The system of claim 1, wherein at least one football player carries an electronically readable tag that may communicate with the pressure sensing device, the position sensing device and the data collection means.

11. The system of claim 1 wherein the pressure sensing device comprises a means for recording a football player's force of impact.

12. The system of claim 1 wherein the pressure sensing device data recordation signals the point at which data recordation ends.

13. The system of claim 1 wherein the data collection device is configured to automatically begin data collection at a specific time interval.

14. The system of claim 1 wherein the data collection device is configured to begin recording data upon manual activation.

15. The system of claim 1 wherein the means for storing data is a database.

16. A system for training and assessing football players' performance comprising:
a mobile device comprising a signal receiver and a wireless transceiver;
a server being in wireless communication with the mobile device; and
wherein the receiver records biometric data relating to football player's speed, strength, and agility.

17. The system of claim 16, further comprising a plurality of pressor sensing devices.

18. A method for training and assessing at least one football player comprising:
arranging the football players in a desired play pattern, at least one of the football players having a data collection sensor;
initiating data recordation via a command through a personal computer in connection with a data collection device;
measuring a player's performance during a football play, wherein the performance is measured in terms of time, force, and play execution;
assessing a player's strengths and weaknesses as they relate to executing a football play;
adjusting the player's training regimen accordingly; and
repeating the above steps as needed to generate a profile for at least one player.

19. The method of claim 17, wherein the method is used to collect data on a plurality of football players and organized by player position.

20. The method of claim 17, wherein the data recordation is initiated through a mobile device.
